(19) United States
(12) Patent Application Publication
(10) Pub. No.: US 2008/0024664 A1
(43) Pub. Date: Jan. 31, 2008

(54) Video signal processing apparatus and video signal processing method

(75) Inventor: Takahiro Kimura, Tokyo (JP)

Correspondence Address: PILLSBURY WINTHROP SHAW PITTMAN, LLP, P.O. BOX 10500, MCLEAN, VA, 22102, US

(73) Assignee: Kabushiki Kaisha Toshiba, Tokyo (JP)

(21) Appl. No.: 11/878,373

(22) Filed: Jul. 24, 2007

(30) Foreign Application Priority Data
Jul. 31, 2006 (JP) 2006-208474

(51) Int. Cl. H04N 5/46

(52) U.S. Cl. 348/558; 348/E05.114

(57) ABSTRACT

According to one embodiment, a video signal processing apparatus has a display device displaying video, and causes the display device to display video by processing an input video signal inputted from an external apparatus. The video signal processing apparatus also has an apparatus-related information acquiring unit acquiring apparatus-related information concerning the external apparatus from the external apparatus, an apparatus detection unit detecting that the external apparatus which is specific is connected based on the apparatus-related information acquired by the apparatus-related information acquiring unit, and an adjustment value switching unit switching a display adjustment value for causing the display device to display video to a peculiar display adjustment value peculiar to the specific external apparatus when it is detected that the specific external apparatus is connected by the apparatus detection unit.

### CROSS-REFERENCE TO RELATED APPLICATIONS

This application is based upon and claims the benefit of priority from Japanese Patent Application No. 2006-208474, filed Jul. 31, 2006, the entire contents of which are incorporated herein by reference.

### BACKGROUND

1. Field

One embodiment of the invention relates to a video signal processing apparatus such as a television, a projector, a monitor and an optical disk reproducing apparatus which process video signals, and a video signal reproducing method by the video signal processing apparatus.

2. Description of the Related Art

Video display apparatuses such as a television, a projector and a monitor which display video by using video signals reproduced by receiving broadcast waves or video signals inputted from an outside are conventionally known. Video reproducing apparatus which read digital data recorded in recording media such as a DVD (Digital Versatile Disk) and an HDD (Hard Disk Drive), reproduce video signals, and output the reproduced video signals to video display apparatuses are also known.

For example, Japanese Patent Application Publication (KOKAI) No. 2005-167895 (Patent Document 1) discloses a video signal output apparatus which automatically discriminates a video format of a video display apparatus connected to it and displays the video format on a menu screen.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram showing a digital broadcast receiving apparatus, and a configuration of a network system configured with the digital broadcast receiving apparatus as a center according to an embodiment of the invention;

FIG. 2 is an exemplary block diagram showing a main configuration of an inside of the digital broadcast receiving apparatus in the embodiment;

FIG. 3 is an exemplary flowchart showing an operation procedure of an external apparatus interlocking operation in the embodiment;

FIG. 4 is an exemplary view showing one example of video displayed when a specific external apparatus is connected in the embodiment;

FIG. 5 is an exemplary view showing one example of explanation display in the embodiment;

FIG. 6 is an exemplary view showing one example of a menu screen concerning the external apparatus interlocking operation in the embodiment;

FIG. 7 is an exemplary view showing one example of video during broadcast reception in the embodiment; and

FIG. 8 is an exemplary view showing one example of a switch message in the embodiment.

### DETAILED DESCRIPTION

Various embodiments according to the invention will be described hereinafter with reference to the accompanying drawings. In general, according to one embodiment of the invention, a video signal processing apparatus has a display device displaying video, and causes the display device to display video by processing an input video signal inputted from an external apparatus. The video signal processing apparatus also has an apparatus-related information acquiring unit acquiring apparatus-related information concerning the external apparatus from the external apparatus, an apparatus detection unit detecting that the external apparatus which is specific is connected based on the apparatus-related information acquired by the apparatus-related information acquiring unit, and an adjustment value switching unit switching a display adjustment value for causing the display device to display video to a peculiar display adjustment value peculiar to the specific external apparatus when it is detected by the apparatus detection unit that the specific external apparatus is connected.

Further, a video signal processing method in a video signal processing apparatus includes acquiring apparatus-related information concerning the external apparatus from the external apparatus, detecting that the external apparatus which is specific is connected based on the acquired apparatus-related information, and switching a display adjustment value for causing the display device to display video to a peculiar display adjustment value peculiar to the specific external apparatus, when it is detected that the specific external apparatus is connected.

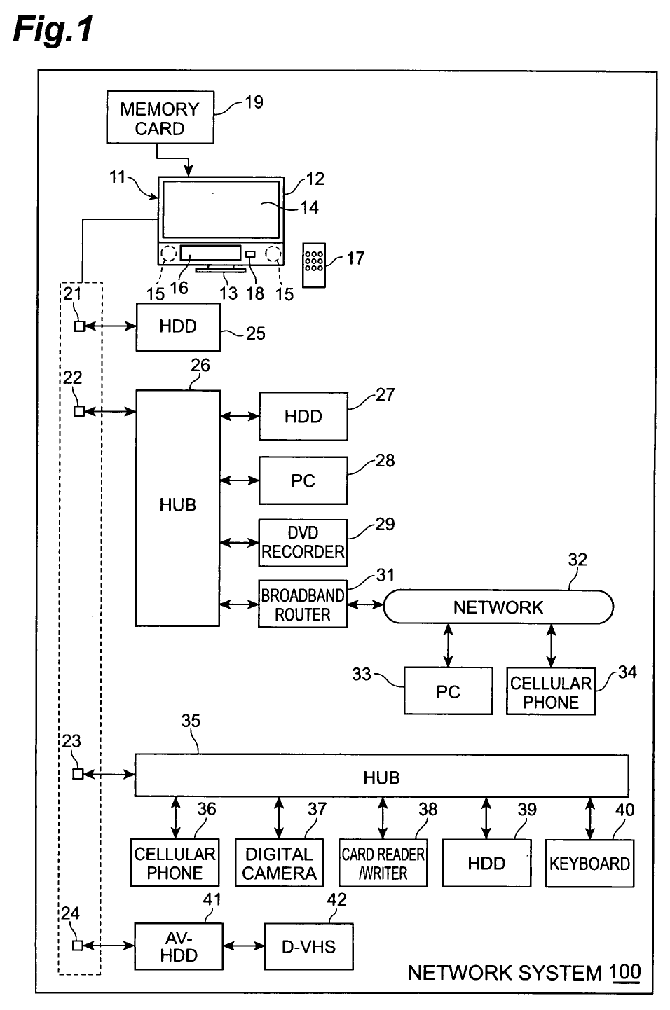

FIG. 1 is a block diagram showing a digital broadcast receiving apparatus 11 according to an embodiment of the present invention, and a configuration of a network system 100 configured with the digital broadcast receiving apparatus 11 as a center.

The digital broadcast receiving device 11 has a cabinet 12, and a support table 13 supporting the cabinet 12 with the cabinet 12 raised. The cabinet 12 has a flat panel type liquid crystal device 14 including a liquid crystal panel, a speaker 15 as a sound output device outputting sound, and an operation part 16, and also has a light receiving part 18 receiving operation information transmitted from a remote controller 17.

The digital broadcast receiving apparatus 11 is a video display apparatus capable of displaying video by the liquid crystal display device 14 as a display device which displays video, and has a function as a video signal processing apparatus which displays video by using input video signals inputted therein from a later-described DVD recorder 29.

A memory card 19 such as an SD (Secure Digital) memory card, an MMC (Multi Media Card) and a memory stick is attachable and detachable to and from the digital broadcast receiving apparatus 11, and by using the memory card 19, recording and reproducing a program, photograph and the like are performed by using the memory card 19.

The digital broadcast receiving apparatus 11 includes a LAN (Local Area Network) terminal 21, an HDMI (High-Definition Multimedia Interface) terminal 22, a USB (Universal Serial Bus) terminal 23 and an i. Link terminal 24 (i. Link and HDMI are the registered trademarks).

The LAN terminal 21 is used as a LAN-compatible HDD exclusive port. This LAN terminal 21 is used for recording and reproducing information by Ethernet (trademark) to and from a LAN compatible HDD (Hard Disk Drive) 25 as a connected NAS (Network Attached Storage).

As above, in the network system 100, by providing the LAN terminal 21 as the LAN compatible HDD exclusive port, information recording of a program by high definition quality can be stably performed for the HDD 25 without being influenced by the other network environment, a network usage state and the like.

The HDMI terminal 22 is used as a terminal for inputting and outputting high definition digital video signals and digital sound signals in accordance with the HDMI standards. An HDD 27, a PC (Personal Computer) 28 and a DVD recorder 29 with a built-in HDD are connected to the HDMI terminal 22 through a hub 26 and an HDMI cable as external apparatuses, and the HDMI terminal 22 is used for transmitting information to and from these external apparatuses.

The digital broadcast receiving apparatus 11 can input therein video signals, sound signals and control signals in digital form by the HDMI terminal 22.

A PC 33 and a cellular phone 34 are connected to the HDMI terminal 22 through a broadband router 31 connected to the hub 26, and a network 32 such as the Internet, and the HDMI terminal 22 is used for transmitting information to and from the PC 33 and the cellular phone 34.

The USB terminal 23 is used as a general USB compatible port. USB equipment such as a cellular phone 36, a digital camera 37, a card reader/writer 38 for a memory card, an HDD 39, and a keyboard 40 is connected to the USB terminal 23 through a hub 35, and the USB terminal 23 is used for transmitting information to and from such USB equipment.

An AV-HDD 41, a D (digital)-VHS (Video Home System) 42, for example, and the like are serially connected to the i. Link terminal 24, and the i. Link terminal 24 is used for transmitting information to and from such equipment.

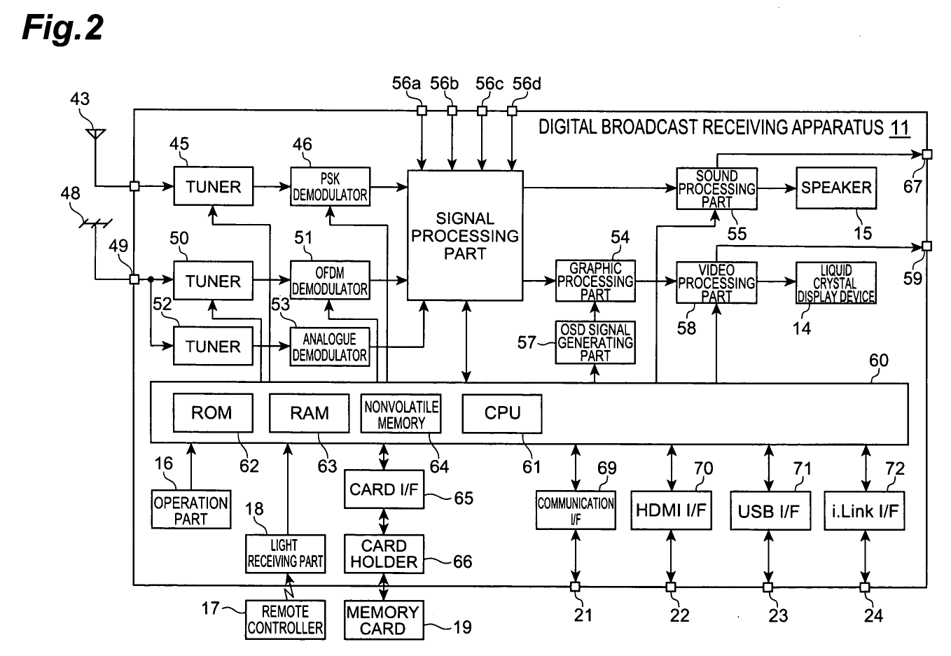

Next, the digital broadcast receiving apparatus 11 will be described with reference to FIG. 2. FIG. 2 shows a block diagram showing a main configuration of an inside of the digital broadcast receiving apparatus 11.

The digital broadcast receiving apparatus 11 has input terminals 44 and 49, tuners 45, 50 and 52, and a PSK (Phase Shift Keying) demodulator 46. The digital broadcast receiving apparatus 11 also has a signal processing part 47, an OFDM (Orthogonal Frequency Division Multiplexing) demodulator 51, an analog demodulator 53, a graphic processing part 54, a sound processing part 55, an OSD signal generating part 57 and a video processing part 58.

Satellite digital broadcast signals received at the BS/CS digital broadcast receiving antenna 43 are inputted into the input terminal 44. The satellite digital broadcast signals are supplied to the tuner 45 from the input terminal 44. The tuner 45 is a tuner for satellite digital broadcast, and selects a broadcast signal of a desired channel from satellite digital broadcast signals which are supplied to it.

The broadcast signal which is selected by the tuner 45 is supplied to the PSK demodulator 46. The PSK demodulator 46 performs demodulating processing of digital video signals and sound signals, and output them to the signal processing part 47.

Terrestrial digital broadcast signals received by a terrestrial broadcast receiving antenna 48 are inputted into the input terminal 49. Terrestrial digital broadcast signals are supplied to the tuner 50 from the input terminal 49. The tuner 50 is a tuner for terrestrial digital broadcast, and selects a broadcast signal of a desired channel from the terrestrial digital broadcast signals which are supplied to it.

The broadcast signal selected by the tuner 50 is supplied to the OFDM demodulator 51. The OFDM demodulator 51 performs demodulating processing of digital video signals and sound signals, and outputs them to the signal processing part 47.

Terrestrial analogue broadcast signals received by the terrestrial broadcast receiving antenna are also inputted into the input terminal 49. The terrestrial analogue broadcast signals are supplied to the tuner 52 from the input terminal 49. The tuner 52 is a tuner for terrestrial analogue broadcast, and selects a broadcast signal of a desired channel from the terrestrial analogue broadcast signals which are supplied to it.

The broadcast signal selected by the tuner 52 is supplied to the analogue demodulator 53. The analogue demodulator 53 performs demodulating processing of analogue video signals and sound signals, and outputs them to the signal processing part 47.

The signal processing part 47 selectively applies predetermined digital signal processing to the digital video signals and sound signals supplied respectively from the PSK demodulator 46 and the OFDM demodulator 51, and outputs them to the graphic processing part 54 and the sound processing part 55.

A plurality (four in the case of the illustration) of input terminals 56a, 56b, 56c and 56d are connected to the signal processing part 47. These input terminals 56a to 56d are capable of inputting analogue video signals and sound signals therein from the DVD recorder 29 and the like as the external apparatus.

This signal processing part 47 selectively digitizes the analogue video signals and sound signals supplied respectively from the analogue demodulator 53 and the respective input terminals 56a to 56d. The signal processing part 47 applies predetermined digital signal processing to the digitized video signals and sound signals, and thereafter, outputs them to the graphic processing part 54 and the sound processing part 55.

The graphic processing part 54 superimposes OSD signals generated in the OSD (On Screen Display) signal generating part 57 on the digital video signals supplied from the signal processing part 47, and outputs them. The graphic processing part 54 can selectively output the output video signals of the signal processing part 47 and the OSD signals outputted by the OSD signal generating part 57, and also can output both the output video signals and OSD signals in combination so that both the outputs constitute halves of the screen respectively.

The digital video signals outputted from the graphic processing part 54 are supplied to the video processing part 58. The video processing part 58 converts the inputted digital video signals into analogue video signals in a format displayable in the liquid crystal display device 14, and thereafter, outputs them to the liquid crystal display device 14. The video processing part 58 also leads the analogue video signals to the outside through an output terminal 59.

The sound processing part 55 converts the inputted digital sound signals into analogue sound signals in a format reproducible in a speaker 15, and thereafter, outputs them to the speaker 15. The sound processing part 55 also leads the analogue sound signals to the outside through an output terminal 67.

The digital broadcast receiving apparatus 11 has a control part 60, a cardholder 66 and various kinds of interfaces 65, 69, 70, 71 and 72.

The control part 60 has a CPU (Central Processing Unit) 61, a ROM (Read Only Memory) 62, a RAM (Random Access Memory) 63 and a nonvolatile memory 64. The control part 60 generally controls the operations of the digital broadcast receiving apparatus 11 including an operation of receiving broadcast signals. The control part 60 receives operation information from the operation part 16, or receives the operation information sent out from the remote controller 17 through the receiving part 18, and controls each part so that the operation content is reflected.

The CPU 61 inputs and outputs signals from and to the other components, and performs operation control of the entire digital broadcast receiving apparatus 11 while operating as various kinds of units (a apparatus-related information acquiring unit, a apparatus detection unit, an adjustment value switching unit and the like).

The ROM 62 mainly stores a control program executed mainly by the CPU 61. The RAM 63 provides an operation area to the CPU 61. The nonvolatile memory 64 stores various kinds of setting information, control information and the like.

The control part 60 is connected to the card holder 66, to which the memory card is fittable, through the card I/F (Interface) 65. Thereby, the control part 60 can transmit information to and from the memory card 19 fitted to the card holder 66 through the card I/F 65.

The control part 60 is also connected to a LAN terminal 21 through the communication I/F 69. Thereby, the control part 60 can transmit information to and from the LAN compatible HDD 25 connected to the LAN terminal 21. In this case, the control part 60 has a DHCP (Dynamic Host Configuration Protocol) server function, and assigns an IP (Internet Protocol) address to the LAN compatible HDD 25 connected to the LAN terminal 21, and controls it.

The control part 60 is connected to the HDMI terminal 22 through the HDMI I/F 70. Thereby, the control part 60 can transmit information to and from each of the external apparatuses (see FIG. 1) connected to the HDMI terminal 22 through the HDMI I/F 70.

The control part 60 is also connected to the USB terminal 23 via the USB I/F 71. Thereby, the control part 60 can transmit information to and from each of the external apparatuses (see FIG. 1) connected to the USB terminal 23 through the USB I/F 71.

Further, the control part 60 is connected to the i. Link terminal 24 through the i. Link I/F 72. Thereby, the control part 60 can transmit information to and from each of the external apparatuses (see FIG. 1) connected to the i. Link terminal 24 through the i. Link I/F 72.

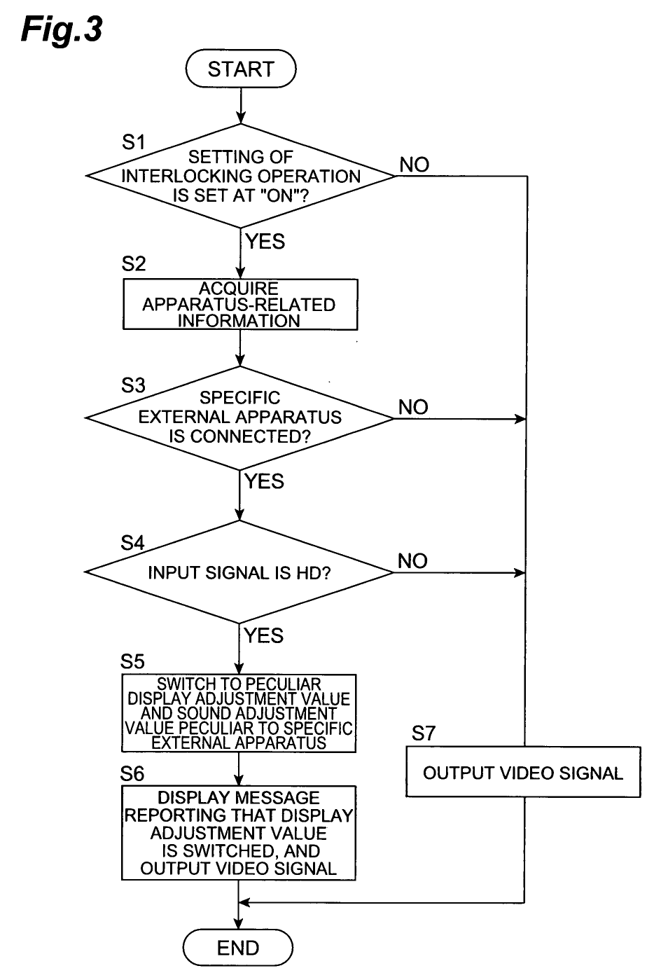

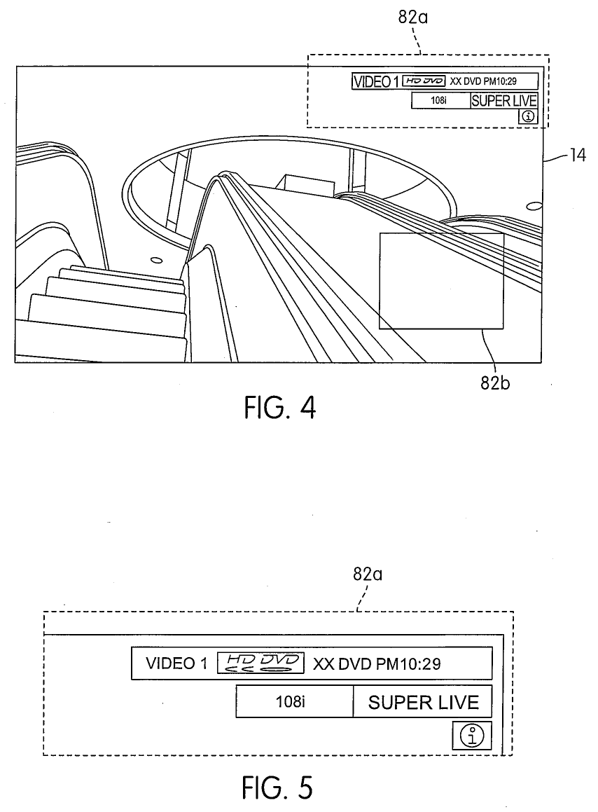

Next, an external apparatus interlocking operation of the digital broadcast receiving apparatus 11 having the above configuration will be described. FIG. 3 is a flowchart showing an operation procedure of the external apparatus interlocking operation by a control program of the external apparatus interlocking operation.

In this case, the external apparatus interlocking operation means the operation of automatically performing later-described adjustment value switching in such a manner as to be interlocked with a connected external apparatus, and the external apparatus interlocking operation is realized by the control part 60 performing an operation following the flowchart shown in FIG. 3.

In the digital broadcast receiving apparatus 11, a user sets whether or not to perform the external apparatus interlocking operation by performing a predetermined operation (hereinafter, called “remote controller operation”) using the remote controller 17, and the like in advance. The digital broadcast receiving apparatus 11 performs the external apparatus interlocking operation only when the setting for executing the external apparatus interlocking operation is made.

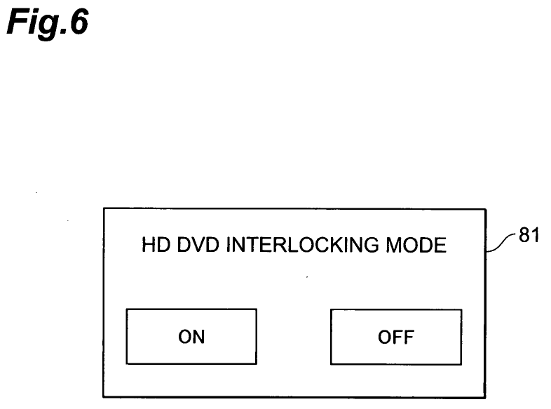

The digital broadcast receiving apparatus 11 can cause the liquid crystal display device 14 to display a menu screen 81 relating to the external apparatus interlocking operation as shown in FIG. 6. When the user selects “ON” following the menu screen 81, the CPU 61 performs an operation as a setting unit to make the setting for executing the external apparatus interlocking operation (for example, turning on a setting flag, or the like).

When the input source of the video signals changes, the CPU 61 of the control part 60 executes the control program of the external apparatus interlocking operation stored in the ROM 62. This is for the situation where video is to be displayed by switching the video signals of the terrestrial analogue broadcast which is obtained by receiving the broadcast waves with the tuner 52 and reproducing them to video signals inputted from the HDMI terminal 22 by changing the input terminal by the remote control operation, for example.

In the case of the above described digital broadcast receiving apparatus 11, the connected external apparatuses are HDD 27, the PC 28, the DVD recorder 29, the digital camera 37 and the like, and in this embodiment, explanation will be made by assuming that the DVD recorder 29 is the specific external apparatus among them. However, the embodiment is applicable to the cases where the external apparatuses other than the DVD recorder 29 are the specific external apparatuses.

The DVD recorder 29 as the specific external apparatus is assumed to be a DVD recorder based on the HD-DVD standards (hereinafter, called “HD-DVD recorder”), but this embodiment is not limited to this.

The CPU 61 of the control part 60 starts execution of the control program of the external apparatus interlocking operation, and then, forwards the process to block 1, where it determines whether or not the setting of the external apparatus interlocking operation is “on”.

If the setting of the external apparatus interlocking operation is “on” here, the CPU 61 forwards the process to block 2. Otherwise, it ends the process. The external apparatus interlocking operation is realized by the process of the block 2 and the following blocks, and therefore, by switching the process in the block 1, the CPU 61 performs the operation as a control unit.

When forwarding the process to the block 2, the CPU 61 performs the operation as a apparatus-related information acquiring unit, and acquires, from the DVD recorder 29 as the external apparatus, its method, standards, type and the other apparatus-related information concerning the DVD recorder 29.

Next, when forwarding the process to block 3, the CPU 61 performs an operation as a apparatus detection unit, and determines whether or not a specific external apparatus is connected, based on the apparatus-related information acquired in the block 2.

Here, if the CPU 61 determines that the specific external apparatus is connected, it forwards the process to block 4, but if not so, it forwards the process to block 7.

When forwarding the process to the block 4, the CPU 61 performs the operation as a video signal discrimination unit, discriminates an input video signal inputted through the HDMI terminal 22, and determines whether or not the input video signal is HD (High-Definition). Here, if the CPU 61 determines the input video signal is HD, it forwards the process to block 5, but if not so, it forwards the process to the block 7.

When the CPU 61 forwards the process to the block 5, it performs the operation as an adjustment value switching unit, and switches display adjustment values (parameters for image quality adjustment such as brightness, a color tone, color shade, hue and color saturation, for example), and sound adjustment values (parameters for sound quality adjustment such as noise reduction, and sound directivity) for outputting sound from the speaker 15 to peculiar display adjustment values and peculiar sound adjustment value peculiar to the DVD recorder 29 respectively (hereinafter, the switching will be called “adjustment value switching”).

When further forwarding the process to block 6 subsequently, the CPU 61 performs the operation as a message display control unit, and causes the liquid crystal display device 14 to display a switch message 83. The switch message 83 is the message for reporting the user that the display adjustment values have been switched to the peculiar display adjustment values. The CPU 61 performs instruction to output the video signals, and thereafter, finishes the external apparatus interlocking operation.

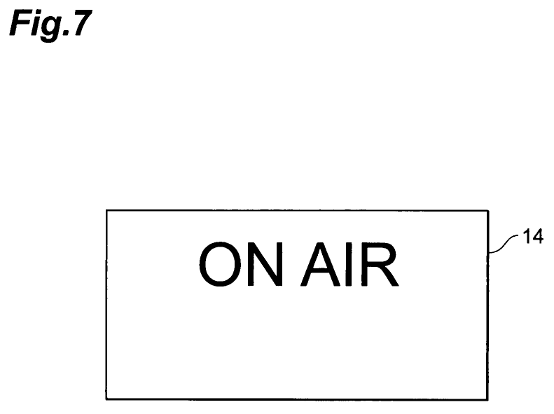

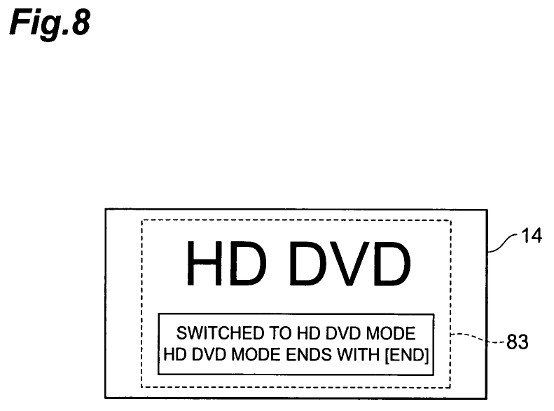

When the block 6 is executed and the external apparatus interlocking operation finishes, the adjustment value switching is performed while the tuner 52 is under reception (“ON AIR”) and the video of the broadcast program is displayed on the liquid crystal display device 14 as shown in FIG. 7, and thereby, the switch message 83 is displayed as shown in FIG. 8.

Then, the CPU 61 receives the instruction to output the video signals and performs the operation as the video display control unit, causes the signal processing part 47 to perform digital signal processing based on the peculiar display adjustment values, and causes the liquid crystal display device 14 to display the high definition video peculiar to the DVD recorder 29. The CUP 61 also causes the signal processing part 47 to perform digital signal processing based on the peculiar sound adjustment values, and outputs the high-quality sound peculiar to the DVD recorder 29 from the speaker 15. Then, the video as shown in FIG. 14, for example, is displayed on the liquid crystal display device 14.

Further, the CPU 61 performs an operation as an external apparatus information display control unit, and displays explanation display 82a at the upper right of the display screen and explanation display 82b at the lower right.

The explanation display 82a displays the characteristics, the functions and the like concerning the video display and sound output such as display of the terminal (“video 1”) to which the DVD recorder 29 as a specific external apparatus is connected, a logo mark of a HD-DVD, a present time, resolution (1080i), and a sound output mode (“super live”).

In the explanation display 82b, explanation of the characteristics and function other than video display and sound output (for example, “this HD-DVD recorder can reproduce a CD (Compact Disk)”, and the like) are displayed. The specific external apparatus information is constituted of the explanation display 82a and the explanation display 82b.

In the block 7, the CPU 61 performs the instruction to output the video signal, and thereafter, ends the external apparatus interlocking operation.

As described above, in the digital broadcast receiving apparatus 11, when the input source of the video signal is switched, the display adjustment value is automatically switched to the peculiar display adjustment value peculiar to the DVD recorder 29 as the specific external apparatus without a manual operation of the user.

Therefore, even if the user switches the input source of the video signal, the user does not need to set the display adjustment value all over again for himself, and therefore, in the digital broadcast receiving apparatus 11, complicatedness required for adjustment and setting is eliminated, and convenience is enhanced.

Switching of the display adjustment value is performed in accordance with the result of discrimination of the input video signal, and therefore, the switched peculiar display adjustment value can be made a suitable value corresponding to the input video signal. Video is displayed based on the peculiar display adjustment value, and therefore, high definition video peculiar to the DVD recorder 29 as the specific external apparatus is displayed on the liquid crystal display device 14.

Further, when the adjustment value switching is performed in the digital broadcast receiving apparatus 11, the switch message 83 indicating this is displayed on the liquid crystal display device 14. Therefore, the digital broadcast receiving apparatus 11 can report the user that the adjustment value switching is performed, and the user can reliably grasp this.

In addition, the explanation displays 82a and 82b are displayed on the liquid crystal display device 14, and therefore, the user can confirm the characteristics, the function and the other information of the DVD recorder 29 as the external apparatus by the screen display.

The digital broadcast receiving apparatus 11 allows the user to set whether or not to perform adjustment value switching, and can execute adjustment value switching in accordance with the setting. Accordingly, the digital broadcast receiving apparatus 11 allows the user to determine whether or not to perform adjustment value switching at will.

In the above described explanation, in the digital broadcast receiving apparatus 11, the adjustment value switching is performed, so that a user do not have to readjust the values manually, but vide signal switching may be performed in the DVD recorder 29 as the video reproducing apparatus.

In this case, the DVD recorder 29 has the following respective units. Namely, the DVD recorder 29 has the apparatus-related information acquiring unit which acquires apparatus-related information from the connected external apparatus, the apparatus detection unit which detects that the specific external apparatus (for example, the digital broadcast receiving apparatus 11) is connected based on the acquired apparatus-related information, and the video signal switching unit which switches an output video signal in accordance with the specific external apparatus when it is detected by the apparatus detection unit that the specific external apparatus is connected.

For example, when the external apparatus is changed to a video display device which displays the video of high definition television broadcast (HD: High Definition) from the video display device which displays the video of standard definition broadcast (SD: Standard Definition), the DVD recorder 29 switches the video signal, and outputs a video signal to which the video signal is switched.

The above description is the description about the embodiment of the preset invention and is not intended to limit the apparatus and the method of the present invention, and various modified examples can be easily carried out. The apparatuses or method which are constituted by properly combining the components, functions, characteristics or the method blocks in each of the embodiments are also included in the present invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A video signal processing apparatus having a display device displaying video, and causing the display device to display video by processing an input video signal inputted from an external apparatus, comprising:
an apparatus-related information acquiring unit acquiring apparatus-related information concerning the external apparatus from the external apparatus;
an apparatus detection unit detecting that the external apparatus which is specific is connected based on the apparatus-related information acquired by the apparatus-related information acquiring unit; and
an adjustment value switching unit switching a display adjustment value for causing the display device to display video to a peculiar display adjustment value peculiar to the specific external apparatus when it is detected by the apparatus detection unit that the specific external apparatus is connected.

2. The video signal processing apparatus according to claim 1, further comprising:
a video signal discrimination unit discriminating the input video signal,
wherein said adjustment value switching unit switches the display adjustment value in accordance with a discrimination result of said video signal discrimination unit.

3. The video signal processing apparatus according to claim 1, further comprising:
a message display control unit causing the display device to display a switch message indicating that the display adjustment value is switched, when the display adjustment value is switched by said adjustment value switching unit.

4. The video signal processing apparatus according to claim 1, further comprising:
a video display control unit causing the display device to perform video display peculiar to the specific external apparatus based on the peculiar adjustment value, when the display adjustment value is switched by said adjustment value switching unit.

5. The video signal processing apparatus according to claim 1, further comprising:
an external apparatus information display control unit causing characteristics and a function of the specific external apparatus and other specific external apparatus information to be displayed, when the display adjustment value is switched by said adjustment value switching unit.

6. The video signal processing apparatus according to claim 1, further comprising:
a setting unit setting whether or not to switch the display adjustment value by said adjustment value switching unit; and
a control unit controlling said adjustment value switching unit to switch the display adjustment value in accordance with a set content of the setting unit.

7. The video signal processing apparatus according to claim 1, further comprising:
a sound output device outputting sound,
wherein said adjustment value switching unit switches a sound adjustment value for causing said sound output unit to output sound to a peculiar sound adjustment value peculiar to the specific external apparatus when it is detected that the specific external apparatus is connected.

8. A video signal processing apparatus having a video signal reproducing device reading digital data recorded in a recording medium and reproducing a video signal, and outputting the video signal reproduced by the video signal reproducing device, comprising:
an apparatus-related information acquiring unit acquiring apparatus-related information concerning the external apparatus from the external apparatus;
an apparatus detection unit detecting that the external apparatus which is specific is connected based on the apparatus-related information acquired by the apparatus-related information acquiring unit; and
a video signal switching unit switching the video signal in accordance with the specific external apparatus, when it is detected by the apparatus detection unit that the specific external apparatus is connected.

9. A video signal processing method in a video signal processing apparatus having a display device displaying video, and causing the display device to display video by processing an input video signal inputted from an external apparatus, comprising:
acquiring apparatus-related information concerning the external apparatus from the external apparatus;
detecting that the external apparatus which is specific is connected based on the acquired apparatus-related information; and
switching a display adjustment value for causing the display device to display video to a peculiar display adjustment value peculiar to the specific external apparatus, when it is detected that the specific external apparatus is connected.
